(19) United States
(12) Patent Application Publication
(10) Pub. No.: US 2024/0375710 A1
(43) Pub. Date: Nov. 14, 2024

(54) STEERING APPARATUS FOR VEHICLE AND OPERATING METHOD THEREOF

(71) Applicant: HYUNDAI MOBIS CO., LTD., Seoul (KR)

(72) Inventor: Tae Heon LEE, Yongin-si (KR)

(73) Assignee: HYUNDAI MOBIS CO., LTD., Seoul (KR)

(21) Appl. No.: 18/437,964

(22) Filed: Feb. 9, 2024

(30) Foreign Application Priority Data
May 9, 2023 (KR) 10-2023-0059767

(51) Int. Cl. B62D 7/15; B62D 15/02

(52) U.S. Cl. CPC B62D 7/159; B62D 15/021

(57) ABSTRACT

A steering apparatus for a vehicle including a plurality of independently steered wheels, the apparatus including one or more processors configured to execute instructions and a memory storing the instructions, wherein execution of the instructions configures the one or more processors to provide an interface, assign a motion mode of the vehicle based on a manipulation received by the interface, determine target angles of the plurality of independently steered wheels corresponding to the assigned motion mode, and output motion trajectories of the vehicle according to the determined target angles through the interface.

### CROSS-REFERENCE TO RELATED APPLICATION

This application claims the benefit under 35 USC § 119 (a) of Korean Patent Application No. 10-2023-0059767, filed on May 9, 2023, the entire disclosure of which is incorporated herein by reference for all purposes.

### BACKGROUND

### Field

Exemplary embodiments of the present disclosure relate to a steering apparatus for a vehicle and an operating method thereof, and more particularly, to an apparatus and method for independently controlling the steering of each of four wheels.

### Description of the Related Art

An active front steering (AFS) system that is applied to a vehicle includes a steering gear ratio variable apparatus between a steering wheel and a steering actuator, and provides front steering responsiveness and driving stability by receiving a steering angle of the steering wheel, outputting a varied rotation angle to an AFS actuator, and varying a steering gear ratio. Furthermore, a rear wheel steering (RWS) system provides rear wheel steering responsiveness and driving stability in a way to determine a rear wheel angle by receiving a steering angle of the steering wheel and a vehicle speed and to control a rear wheel angle by driving an RWS actuator.

Recently, in order to secure a degree of freedom of the driving of a vehicle like a parallel driving (e.g., parallel parking), diagonal driving (e.g., diagonal parking), or turn-in-place operation of the vehicle, research of a technology for independently controlling the steering of each of four wheels mounted on the vehicle is being carried out. In the case of two-wheel steering (or front wheel steering), two front wheels are mutually mechanically connected through an Ackerman geometry model and perform front wheel steering. In contrast, in the case of four-wheel independent steering, the angle of each wheel needs to be independently controlled because the four wheels are not mutually mechanically connected.

A motion of a vehicle to which a conventional two-wheel steering or front wheel steering system has been applied and a motion of a vehicle to which a four-wheel independent steering system has been applied are inevitably different from each other. Accordingly, a driver who is used to the conventional two-wheel steering or front wheel steering system may feel a sense of incompatibility with a motion of a vehicle according to the four-wheel independent steering system. That is, if a common turning operation, turn-in-place operation, parallel driving, or diagonal driving of a vehicle is performed based on the four-wheel independent steering system, a driver may feel a sense of incompatibility when executing a corresponding motion because the driver cannot intuitively determine a motion trajectory of the vehicle according to the corresponding motion, and cannot also intuitively determine whether a surrounding free space in which a motion of the vehicle is possible has been secured. Moreover, a surrounding object (e.g., a pedestrian) of a vehicle is exposed to a danger of collision against the vehicle because the object cannot predict a motion of the vehicle according to the four-wheel independent steering system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a steering apparatus for a vehicle, the vehicle including a plurality of independently steered wheels, the apparatus including one or more processors configured to execute instructions and a memory storing the instructions, wherein execution of the instructions configures the one or more processors to provide an interface, assign a motion mode of the vehicle based on a manipulation received by the interface, determine target angles of the plurality of independently steered wheels corresponding to the assigned motion mode, and output motion trajectories of the vehicle according to the determined target angles through the interface.

When the manipulation corresponds to a first manipulation that has been predefined, the one or more processors are further configured to assign the motion mode to be a common turn mode, determine a center of rotation of the vehicle in response to the first manipulation, calculate a target angle of each wheel at which the vehicle is turned on a basis of the center of rotation, based on the determined center of rotation and a predefined steering condition for the plurality of independently steered wheels, and provide turn trajectories of the vehicle according to the calculated target angles through the interface.

The predefined steering condition includes a condition in which a straight line connecting the center of rotation and each wheel and each wheel are perpendicular to each other, and the one or more processors are further configured to calculate the target angle of each wheel by using a coordinate of each wheel and a coordinate of the center of rotation as factors, based on a rectangular coordinate system in which a coordinate of any one wheel of the plurality of independently steered wheels is an original point.

The first manipulation is a touch received through the interface, the center of rotation of the vehicle is determined in response to the received touch, and the one or more processors are further configured to provide the turn trajectories of the vehicle through the interface in a state in which the touch on the interface has been maintained.

The first manipulation includes a drag across the interface, the drag being received subsequent to the touch, the center of rotation of the vehicle is variably determined responsive to an input of the drag through the interface, and the one or more processors are further configured to provide a process of the turn trajectories of the vehicle, the turb trajectories being variably determined as the center of rotation is changed in response to the input of the drag being changed through the interface.

The steering apparatus may include a sensor configured to detect an object around the vehicle, and when providing the turn trajectories of the vehicle through the interface by changing the turn trajectories of the vehicle in response to the input of the drag, the one or more processors are further configured to provide the turn trajectories of the vehicle through the interface by applying different output methods to a first turn trajectory that overlaps the object detected by the sensor and a second turn trajectory that does not overlap the object detected by the sensor.

When the interface is configured to receive a second manipulation that has been predefined, the one or more processors are further configured to assign the motion mode to be a turn-in-place mode, calculate a target angle of each wheel corresponding to the assigned turn-in-place mode, and provide turn-in-place trajectories of the vehicle according to the calculated target angles through the interface.

When the interface is configured to receive a third manipulation that has been predefined, and the one or more processors are further configured to assign the motion mode to be one of a parallel mode or a diagonal mode, calculate a target angle of each wheel in response to the third manipulation, and provide one of parallel movement trajectories or diagonal movement trajectories of the vehicle according to the calculated target angles through the interface.

The steering apparatus may include a light radiation module configured to radiate light to an outside of the vehicle, and a sound output module configured to output a sound to the outside of the vehicle, the one or more processors are further configured to instruct the light radiation module to display, on a road surface, light corresponding to the motion trajectory of the vehicle and instruct the sound output module to output an operation sound in the motion process of the vehicle.

In a general aspect, here is provided a steering apparatus for a vehicle including one or more processors configured to execute instructions and a memory storing the instructions, an execution of the instructions configures the one or more processors to provide an interface and calculate a target angle of each wheel of the vehicle at which the vehicle is turned on a basis of a center of rotation, based on the center of rotation of the vehicle that is determined in response to a manipulation received by the interface and a steering condition that has been predefined for wheels of the vehicle, the wheels of the vehicle are configured to be independently steered and provide turn trajectories of the vehicle based on the calculated target angles through the interface.

In a general aspect, here is provided a processor-implemented method for controlling steering apparatus for a vehicle, the vehicle including independently steered wheels, the method including assigning a motion mode of the vehicle based on a manipulation received by an interface, determine target angles of the independently steered wheels corresponding to the determined motion mode, and output motion trajectories of the vehicle according to the determined target angles through the interface.

The method may include determining a center of rotation of the vehicle responsive to a first manipulation received through the interface, calculating a target angle of each wheel at which the vehicle is turned on a basis of the center of rotation, based on the determined center of rotation and a predefined steering condition for the independently steered wheels, and providing turn trajectories of the vehicle according to the calculated target angles through the interface.

The method may include assigning the motion mode to be a common turn mode responsive to a first manipulation.

The method may, responsive to receiving a second predefined manipulation, include assigning the motion mode to be a turn-in-place mode, calculating a target angle of each wheel corresponding to the assigned turn-in-place mode, and displaying turn-in-place trajectories of the vehicle according to the calculated target angles through the interface.

The method may, responsive to receiving a third predefined manipulation, include assigning the motion mode to be one of a parallel mode or a diagonal mode, calculating a target angle of each wheel, and displaying one of parallel movement trajectories or diagonal movement trajectories of the vehicle according to the calculated target angles through the interface.

### BRIEF DESCRIPTION OF THE DRAWINGS

FIG. 1 is a block diagram illustrating a steering apparatus for a vehicle according to the present embodiment.

FIG. 2 is an exemplary diagram illustrating an around view image that is displayed through an interface in the steering apparatus for a vehicle according to the present embodiment.

FIGS. 3 to 9 are exemplary diagrams illustrating operations of in a common turn mode in the steering apparatus for a vehicle according to the present embodiment.

FIGS. 10 and 11 are exemplary diagrams illustrating operations in a turn-in-place mode in the steering apparatus for a vehicle according to the present embodiment.

FIGS. 12 and 13 are exemplary diagrams illustrating operations in a parallel mode in the steering apparatus for a vehicle according to the present embodiment.

FIGS. 14 and 15 are exemplary diagrams illustrating operations in a diagonal mode in the steering apparatus for a vehicle according to the present embodiment.

FIGS. 16 and 17 are flowcharts illustrating an operating method of the steering apparatus for a vehicle according to the present embodiment.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

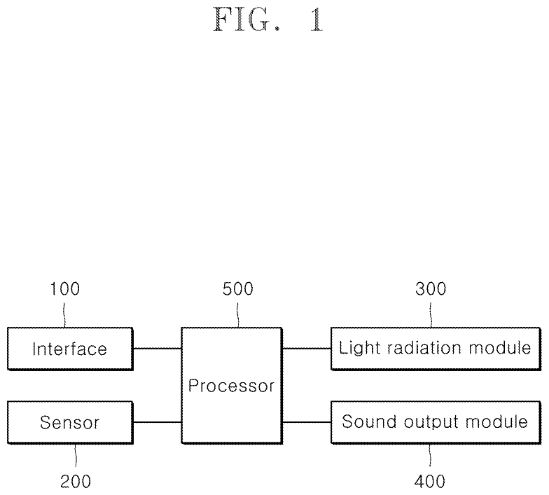

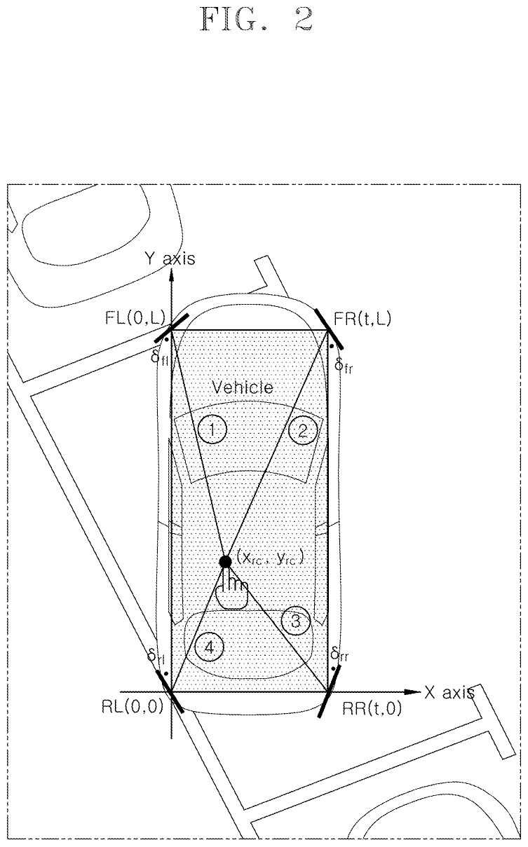

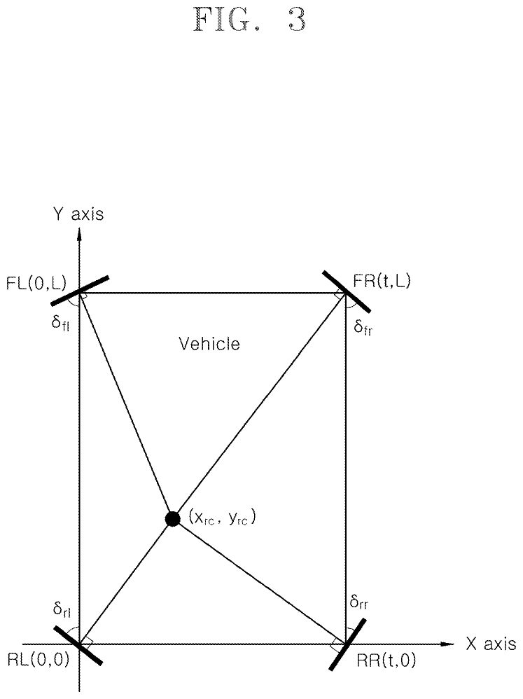

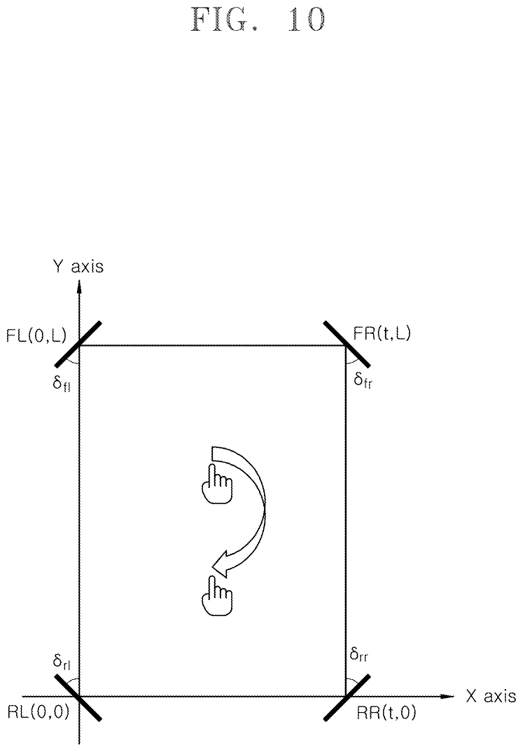

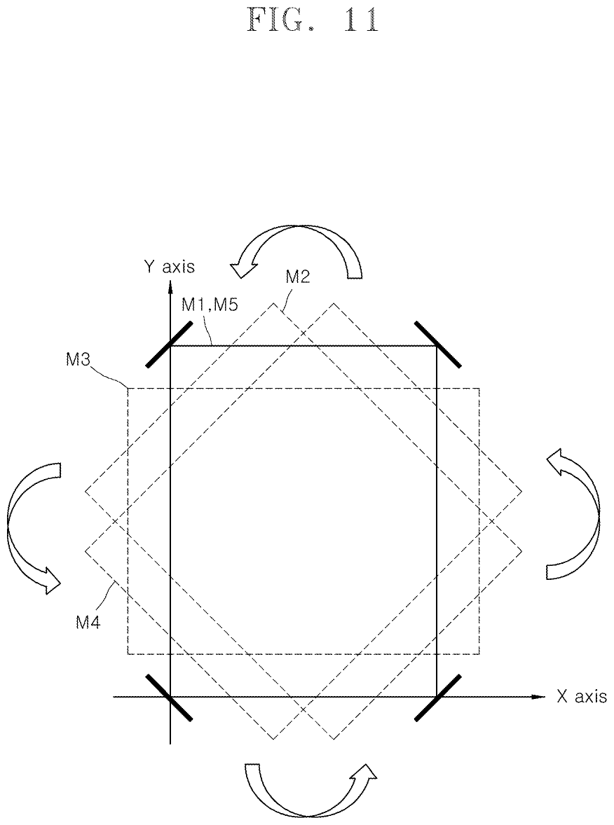

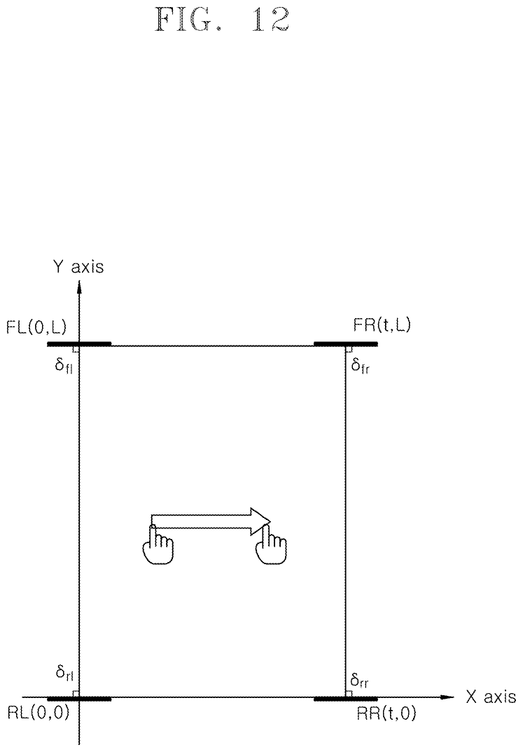

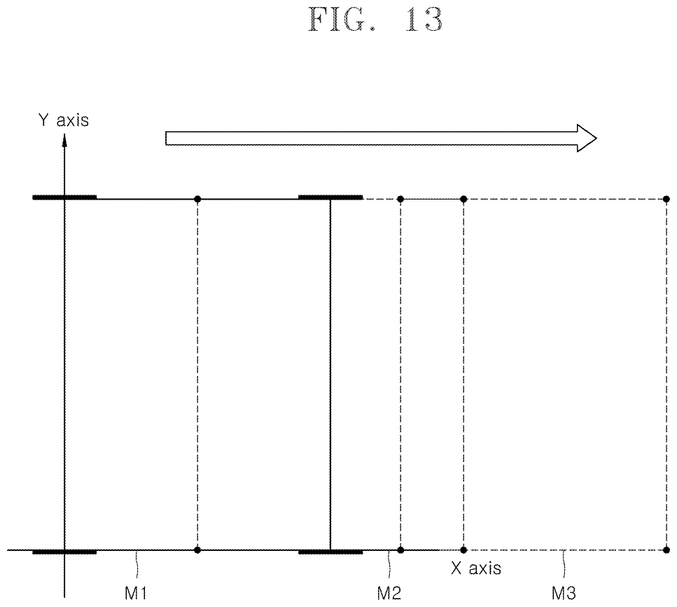

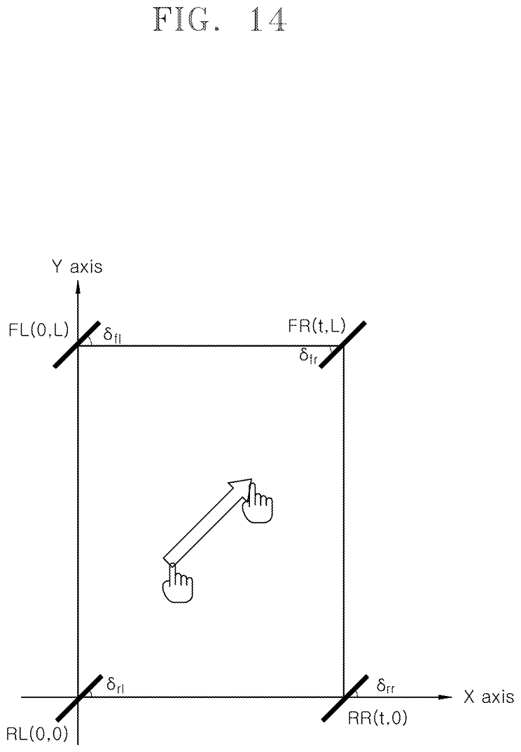

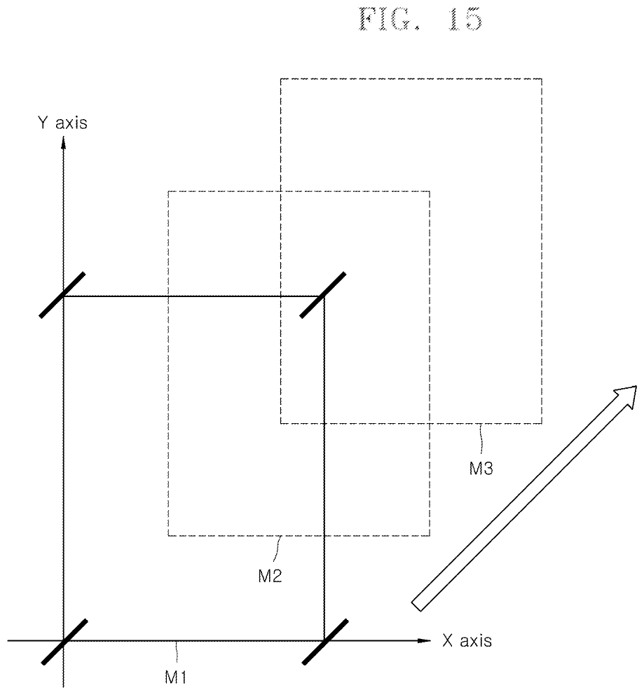

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof. FIG. 1 is a block diagram illustrating a steering apparatus for a vehicle according to the present embodiment. FIG. 2 is an exemplary diagram illustrating an around view image that is displayed through an interface in the steering apparatus for a vehicle according to the present embodiment. FIGS. 3 to 9 are exemplary diagrams illustrating operations of in a common turn mode in the steering apparatus for a vehicle according to the present embodiment. FIGS. 10 and 11 are exemplary diagrams illustrating operations in a turn-in-place mode in the steering apparatus for a vehicle according to the present embodiment. FIGS. 12 and 13 are exemplary diagrams illustrating operations in a parallel mode in the steering apparatus for a vehicle according to the present embodiment. FIGS. 14 and 15 are exemplary diagrams illustrating operations in a diagonal mode in the steering apparatus for a vehicle according to the present embodiment.

Referring to FIG. 1, the steering apparatus for a vehicle according to the present embodiment may include an interface 100, a sensor 200, a light radiation module 300, a sound output module 400, and a processor 500. The steering apparatus may constitute a part of a four-wheel independent steering system in which four wheels are constructed to be independently steered under the control of the processor 500.

The interface 100 is an input and output device that performs an interfacing function between a user (e.g., a passenger of a vehicle) and the processor 500, and may be implemented in the form of a touch screen for receiving first to third manipulations of a user, that is, factors for determining a motion mode of a vehicle and displaying a motion trajectory of the vehicle, which is determined by the processor 500.

The sensor 200 operates to detect a fixed object or a moving object around a vehicle, and may be constructed to include various object detection sensors, such as an ultrasonic sensor, a LiDAR sensor, an infrared sensor, and a camera sensor, in order to detect an object around the vehicle.

The light radiation module 300 operates to display, on a road surface, light corresponding to a motion trajectory of a vehicle under the control of the processor 500, and may be constructed to include various light radiation devices, such as an LED device and a laser device, in order to radiate light. The light radiation module 300 may be installed at a specific location (e.g., the roof of a vehicle or at the bottom of a door) outside the vehicle within a range in which light can be displayed on a road surface.

The sound output module 400 operates to output a sound to the outside of a vehicle under the control of the processor 500, and may be constructed to include various sound output devices, such as a speaker, in order to output a sound. The sound output module 400 may be installed at a specific location (e.g., a front grill of a vehicle) outside the vehicle within a range in which a sound can be output to the outside.

The processor 500 is the subject that performs associated control over the interface 100, the sensor 200, the light radiation module 300, and the sound output module 400 and independent steering control over each of the wheels of a vehicle, and may correspond to a steering system electronic controller unit (ECU). The processor 500 may control a plurality of hardware or software components connected to the processor 500 by driving an operating system or an application, and may perform various types of data processing and operations. The processor 500 may be constructed to execute at least one instruction stored in memory and to store data, that is, the results of the execution, in the memory.

In the present embodiment, the processor 500 operates to determine a motion mode of a vehicle based on a manipulation of a user for the interface 100, to determine target angles of the plurality of wheels corresponding to the determined motion mode, and to provide the user with motion trajectories of the vehicle according to the determined target angles through the interface 100. The motion mode of the vehicle may include the common turn mode, the turn-in-place mode, the parallel mode, and the diagonal mode. Hereinafter, operations of the present embodiment are divided into the motion modes and specifically described.

### 1. Common Turn Mode

In the present embodiment, the processor 500 operates in association with an around view monitoring (AVM) system applied to a vehicle. Accordingly, as illustrated in FIG. 2, the processor 500 first displays an around view image that is received from the AVM system through the interface 100. In this case, after mapping a rectangular coordinate system to the around view image received from the AVM system, the processor 500 may display the around view image through the interface 100. Specifically, the around view image that is displayed through the interface 100 may have the rectangular coordinate system in which the coordinate of any one wheel (named a reference wheel), among the plurality of wheels, is an original point, a straight line that extends from the reference wheel to a wheel in the transverse direction of the reference wheel is an x axis, and a straight line that extends from the reference wheel to a wheel in the longitudinal direction of the reference wheel is a y axis. In the drawings of this specification, a rectangular coordinate system in which the coordinate of a left rear wheel is the original point, a straight line that connects the left rear wheel and a right rear wheel is the x axis, and a straight line that connects the left rear wheel and a left front wheel is the y axis is illustrated as an example. The above construction is applied to the common turn mode, the turn-in-place mode, the parallel mode, and the diagonal mode in common.

As described above, when a manipulation of a user for the around view image that is displayed in the interface 100 corresponds to the first manipulation that has been predefined, the processor 500 determines a motion mode of the vehicle as the common turn mode. The common turn mode corresponds to a mode in which a vehicle turns on the basis of the center of rotation of the vehicle that is set inside or outside the vehicle. As illustrated in FIG. 2, the first manipulation may include a touch of a user on the interface 100. The processor 500 determines a touch point of the user in the around view image as the center of rotation of the vehicle, and is constructed to have the center of rotation of the vehicle and a two-dimensional coordinates (x_{rc}, y_{rc}) according to the rectangular coordinate system of the around view image.

When the center of rotation of the vehicle is determined, the processor 500 determines a target angle of each wheel at which the vehicle turns on the basis of the determined center of rotation, based on a steering condition that has been predefined with respect to the plurality of wheels of the vehicle and the center of rotation of the vehicle, which has been determined as described above. The steering condition may correspond to a condition in which each of straight lines (i.e., straight lines \textcircled{1} to \textcircled{4} in FIG. 2) that each connect the center of rotation and each wheel and each wheel are perpendicular to each other. Accordingly, the processor 500 determines a target angle of each wheel by using the coordinate of each wheel and the coordinate of the center of rotation as factors on the basis of the rectangular coordinate system of the around view image.

FIG. 3 illustrates a process of a target angle of each wheel being determined when the center of rotation of a vehicle is disposed within the vehicle. If a track width is t, a wheelbase is L, and the coordinate of the center of rotation is (x_{rc}, y_{rc}) ((0<x_{rc}<t) and (0<y_{rc}<L)), the target angle of each wheel may be determined based on Equation 1 according to the steering condition.

$$\begin{matrix}{δ}_{fl} = arctan ( \frac{L - {y}_{rc}}{{x}_{rc}} ) \\ {δ}_{fr} = arctan ( \frac{L - {y}_{rc}}{t - {x}_{rc}} ) \\ {δ}_{rl} = arctan ( \frac{{y}_{rc}}{{x}_{rc}} ) \\ {δ}_{rr} = arctan ( \frac{{y}_{rc}}{t - {x}_{rc}} )\end{matrix} \qquad ( 1 )$$

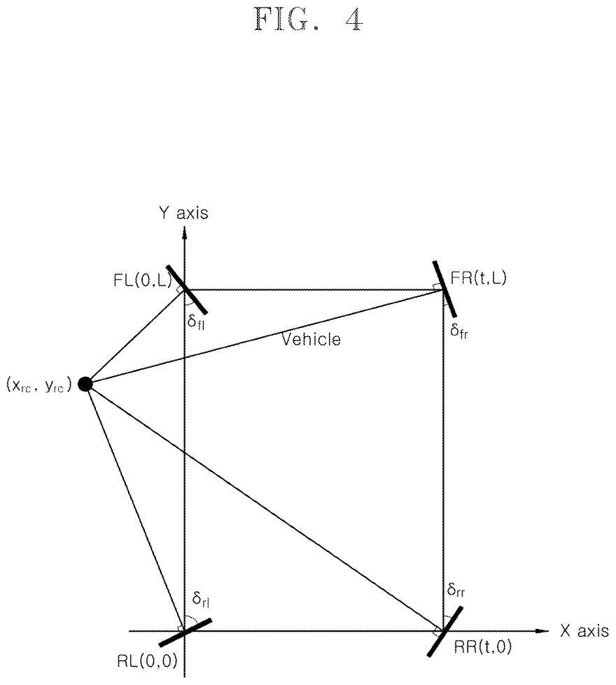

FIG. 4 illustrates a process of a target angle of each wheel being determined when the center of rotation of a vehicle is disposed outside the vehicle. If a track width is t, a wheelbase is L, and the coordinate of the center of rotation is (x_{rc}, y_{rc}) (((x_{rc}<0) or (x_{rc}>t)) and ((y_{rc}<0) or (y_{rc}>L))), the target angle of each wheel may be determined based on Equation 2 according to the steering condition.

$$\begin{matrix}{δ}_{fl} = arctan ( \frac{L - {y}_{rc}}{{x}_{rc}} ) \\ {δ}_{fr} = arctan ( \frac{L - {y}_{rc}}{t - {x}_{rc}} ) \\ {δ}_{rl} = arctan ( \frac{{y}_{rc}}{{x}_{rc}} ) \\ {δ}_{rr} = arctan ( \frac{{y}_{rc}}{t - {x}_{rc}} )\end{matrix} \qquad ( 2 )$$

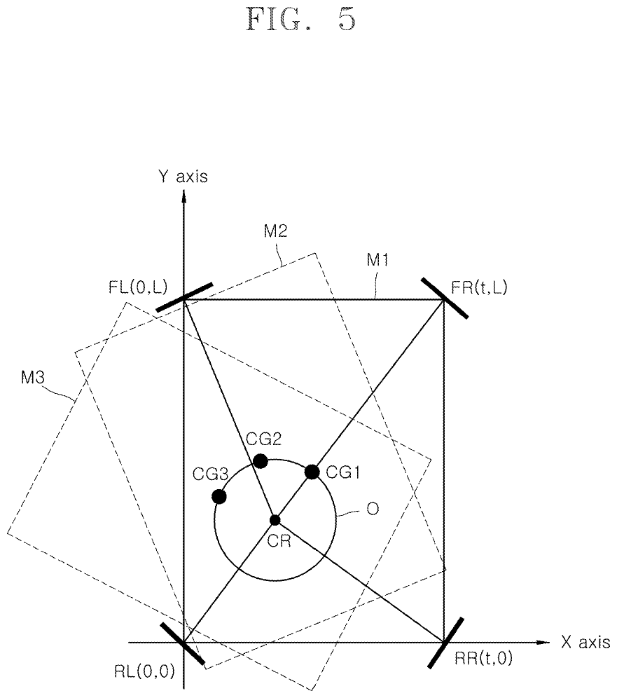

When the target angle of each wheel is determined based on Equation 1 or 2, the processor 500 determines turn trajectories of the vehicle, which are determined based on the determined target angles, and provides a user with the turn trajectories of the vehicle through the interface 100. The turn trajectory corresponds to a moving trajectory of the vehicle, which is formed when each wheel is driven based on the determined target angle of each wheel. FIG. 5 illustrates an example of the turn trajectory (in order to help understanding of an embodiment, a current motion M1 of the vehicle has been illustrated as a solid line and prediction motions M2 and M3 of the vehicle have been illustrated as broken lines, which is identically applied in each of the drawings attached in this specification). Referring to FIG. 5, a central location of the vehicle has the center of rotation CR as its original point, and is moved along a circle (named a reference circle O) that has the center of rotation CR and a first center location CG1 of the vehicle as a radius. As the central location of the vehicle is moved along the reference circle O, the vehicle is turned. FIG. 5 illustrates an example in which the central location of the vehicle is changed into center locations CG1, CG2, and CG3 and a motion of the vehicle is changed along turn trajectories M1, M2, and M3 in accordance with the central locations CG1, CG2, and CG3, respectively. Accordingly, the current motion M1 and prediction motions M2 and M3 of the vehicle constitute the turn trajectories of the vehicle. When each wheel is driven based on the target angle, a trajectory portion that belongs to the entire trajectory in which the vehicle is turned and that is displayed through the interface 100 may be selected on the basis of a case in which each wheel is driven for a set time through set driving torque, for example. The set driving torque and the set time may be designed as specific values depending on experimental results and intention of a designer, and may be previously set in the processor 500.

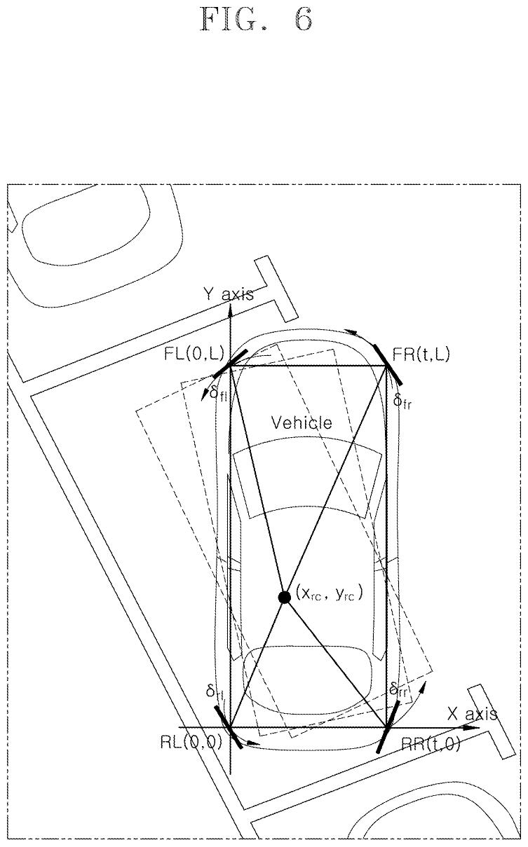

As illustrated in FIG. 6, turn trajectories may also be displayed through the interface 100 in the form of an around view image. A straight line that connects the center of rotation and each wheel and a direction in which each wheel is moved based on a target angle may also be displayed through the interface 100 along with the turn trajectory. Accordingly, a driver can intuitively check the turn trajectories of a vehicle to which a four-wheel independent steering system has been applied.

The processor 500 may display, on a road surface, light corresponding to turn trajectories of a vehicle through the light radiation module 300, and may output an operation sound to the outside of the vehicle through the sound output module 400 in the turn process of the vehicle along the turn trajectories. Accordingly, a surrounding pedestrian can intuitively check the turn trajectories of the vehicle, can walk by avoiding the turn trajectories, and can have awareness of the vehicle through the operation sound.

Furthermore, when an object detected by the sensor 200 is present on the turn trajectories of the vehicle, the processor 500 may provide warning to a user through the interface 100. That is, when a surrounding object is present on turn trajectories according to the center of rotation of the vehicle, which is input by the user, the processor 500 may induce the user to input (or drag to be described later) again the center of rotation by outputting warning to the user through the interface 100 because a sufficient space for a turn operation of the vehicle has not been secured. The warning may be output through the interface 100 by using various methods, such as a visual method and an auditory method.

The first manipulation may include the holding (i.e., the state in which the touch of a user is maintained) of a touch state and a drag that is subsequent to a touch and hold, along with the touch of the user for the interface 100. The first manipulation functions as a component for changing turn trajectories of a vehicle, which are displayed through the interface 100, In this case, it is presupposed that the processor 500 operates to provide the user with the turn trajectories of the vehicle through the interface 100 in the touch and hold state of the user for the interface 100 (as will be described later, “hold” functions as a manipulation that is different from the turn-in-place mode, the diagonal mode, and the parallel mode).

The center of rotation of the vehicle may be constructed to be variably determined in response to the drag of a user for the interface 100. As the center of rotation is changed in response to the drag of the user, the turn trajectories of the vehicle are also variably determined. The processor 500 may display a process of the turn trajectories of the vehicle according to the drag of the user being changed to the user through the interface 100. When providing the turn trajectories of the vehicle through the interface 100 by changing the turn trajectories in response to the drag of the user for the interface 100, the processor 500 may display the turn trajectories to the user through the interface 100 by applying different output methods to a first turn trajectory that overlaps an object detected by the sensor 200 and a second turn trajectory that does not overlaps the object detected by the sensor 200.

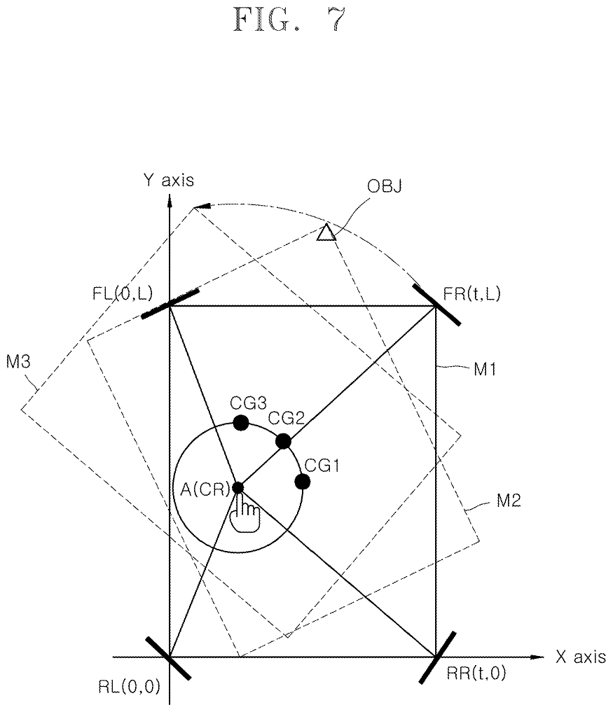

The aforementioned construction is described in detail with reference to FIGS. 7 to 9.

As illustrated in FIG. 7, when a user touches and holds a point A, turn trajectories M1, M2, and M3 of a vehicle having the point A as the center of rotation CR are displayed. The turn trajectories M1, M2, and M3 overlap a surrounding object OBJ of the vehicle (i.e., because the vehicle overlaps the surrounding object OBJ when a motion of the vehicle is sequentially changed along the turn trajectories M1, M2, and M3). Accordingly, the turn trajectories M1, M2, and M3 are displayed through a first method of indicating the unavailableness of the turn trajectories M1, M2, and M3 of the vehicle having the point A as the center of rotation CR. Various methods, such as a method of the turn trajectories M1, M2, and M3 being displayed while blinking, a method of the turn trajectories M1, M2, and M3 being displayed in red, and a method of a state sound (e.g., “the vehicle cannot move along current turn trajectories”) being output, for example, may be applied to the first method within a range in which a driver can recognize the unavailableness of the turn trajectories M1, M2, and M3.

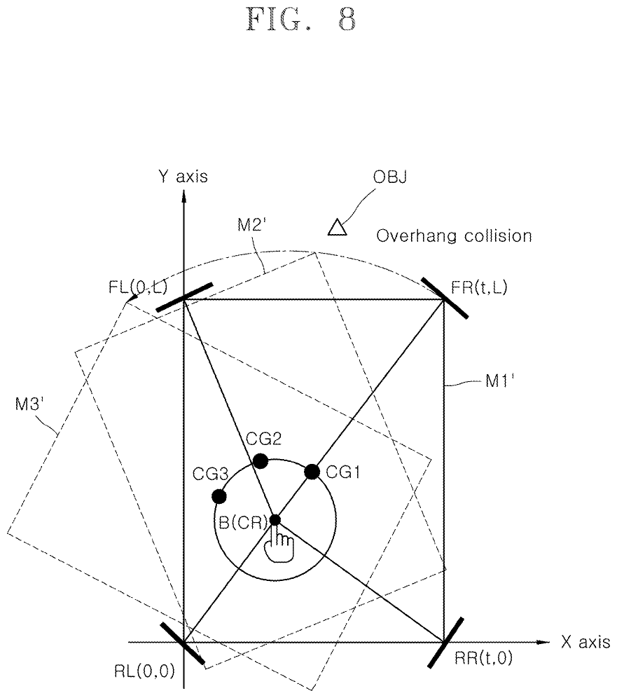

As illustrated in FIG. 8, when the touch point of the user is changed into a point B and held by the drag of the user, turn trajectories M1′, M2′, and M3′ of the vehicle having the point B as the center of rotation CR are displayed. Since an overlap state between the turn trajectories M1′, M2′, and M3′ and the surrounding object OBJ of the vehicle is maintained (i.e., this may be a collision between an overhang portion of the vehicle and the surrounding object OBJ, and an overhang value may be predefined in the processor 500), the turn trajectories M1′, M2′, and M3′ are displayed through the first method of indicating the unavailableness of the turn trajectories M1′, M2′, and M3′ of the vehicle having the point B as the center of rotation CR.

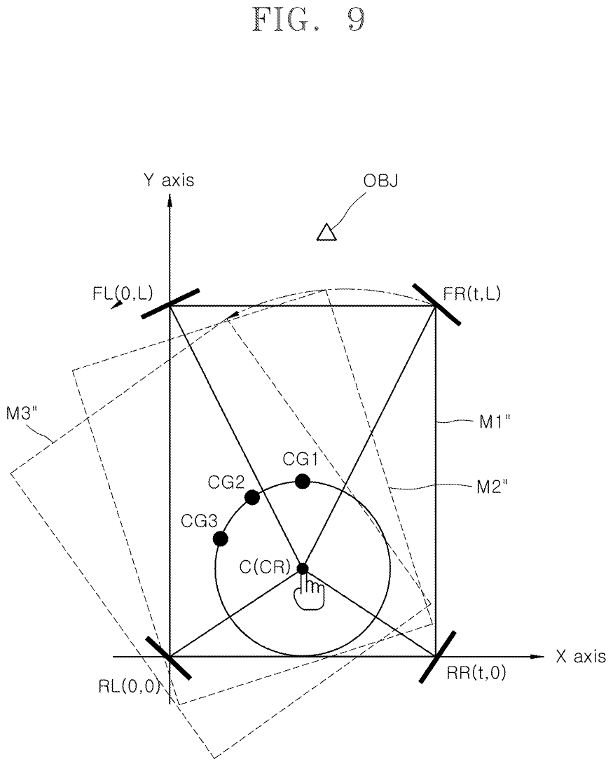

As illustrated in FIG. 9, when the touch point of the user is changed into a point C and held by the drag of the user, turn trajectories M1″, M2″, and M3″ of the vehicle having the point C as the center of rotation CR are displayed. Since a surrounding object of the vehicle, which overlaps the turn trajectories M1 “, M2”, and M3″, is not present, the turn trajectories M1″, M2″, and M3″ are displayed through a second method of indicating the availableness of the turn trajectories M1″, M2″, and M3″ of the vehicle having the point C as the center of rotation CR. Various methods, such as a method of the display states of the turn trajectories M1″, M2″, and M3″ being maintained (i.e., a method of the turn trajectories M1″, M2″, and M3″ not blinking), a method of the turn trajectories M1″, M2″, and M3″ being displayed in blue, and a method of a state sound (e.g., “the vehicle can move along current turn trajectories”) being output, for example, may be applied to the second method within a range in which a driver can recognize the availableness of the turn trajectories M1″, M2″, and M3″ of the vehicle.

According to the above constructions, each turn trajectory when the user changes the center of rotation of the vehicle into the points A to C in a touch and hold manner is displayed along with the effectiveness of each turn trajectory, and user convenience in selecting the turn trajectory can be improved.

It may be preferred that the above function is activated only when the center of rotation of a vehicle is located within the vehicle. A case in which the center of rotation of the vehicle is located outside the vehicle has a greater moving range of the vehicle than a case in which the center of rotation of the vehicle is located within the vehicle. Although a specific turn trajectory is selected among a plurality of turn trajectories that are displayed in a process of the center of rotation of a vehicle being changed outside the vehicle, the selected turn trajectory causes a great moving range of the vehicle. Accordingly, a surrounding object (e.g., a pedestrian, that is, a surrounding object that intervenes upon actual turn operation although the surrounding object was not present when a turn trajectory was selected) that has not been predicted in the process of the vehicle being turned along the turn trajectory may intervene in the turn trajectory, causing a collision against the vehicle. Accordingly, for safety in a turn operation of a vehicle, it may be preferred that the function of providing a turn trajectory of the vehicle through the interface 100 because the turn trajectory of the vehicle is changed in response to the touch & drag of a user for the interface 100 is activated only when the center of rotation of the vehicle is located within the vehicle.

### 2. Turn-In-Place Mode

When a manipulation of a user for an around view image that is displayed in the interface 100 corresponds to the second manipulation that has been predefined, the processor 500 determines a motion mode of a vehicle as the turn-in-place mode. The turn-in-place mode corresponds to a mode in which the center of rotation of a vehicle is fixed and maintained centered on the vehicle (i.e., while the vehicle maintains the same place) and the front and rear directions of the vehicle are changed in the longitudinal direction of the vehicle. The steering condition (i.e., the condition in which each straight line that connects the center of rotation and each wheel and each wheel are perpendicular to each other) that is applied in the common turn mode is identically applied to the turn-in-place mode.

As illustrated in FIG. 10, the second manipulation of a user for determining the turn-in-place mode may include a curve drag of the user for the interface 100. That is, the user may determine a motion mode of a vehicle as the turn-in-place mode in a way to touch the interface 100 and then drag the interface 100 in a curve form. Curvature of the curve for being recognized as the second manipulation for determining the turn-in-place mode by the processor 500 may be predefined as a set range by a designer. Furthermore, for distinguishment from the common turn mode, a meaningful time difference may not be present (i.e., the second manipulation does not include “hold”) between touch timing and curve drag timing of a user for the interface 100 in the second manipulation.

In the turn-in-place mode, the center of rotation of a vehicle is a central location of the vehicle, which corresponds to a case in which (x_{rc}, y_{rc})=(t/2, L/2) in FIG. 3 and Equation 1. Accordingly, a target angle of each wheel is determined according to Equation 3.

$${δ}_{fl} = {δ}_{fr} = {δ}_{rl} = {δ}_{rr} = arctan ( \frac{L}{t} ) \qquad ( 3 )$$

When the target angle of each wheel is determined according to Equation 3, as illustrated as an example in FIG. 11, the processor 500 determines turn-in-place trajectories (M1 to M5 in FIG. 11) of the vehicle, which are formed based on the determined target angle, and provides the turn-in-place trajectories to a user through the interface 100. The turn-in-place trajectories may also be displayed through the interface 100 in the form of an around view image. Accordingly, a driver can intuitively check the turn-in-place trajectories of the vehicle to which the four-wheel independent steering system has been applied.

The processor 500 may display, on a road surface, light corresponding to turn-in-place trajectories of a vehicle through the light radiation module 300, and may output an operation sound to the outside of the vehicle through the sound output module 400 in a turn-in-place process of the vehicle according to the turn-in-place trajectories. Accordingly, a surrounding pedestrian can intuitively check the turn-in-place trajectories of the vehicle, can walk by avoiding the turn-in-place trajectories, and can have awareness of the vehicle through the operation sound.

Furthermore, when an object detected by the sensor 200 is present on turn-in-place trajectories of a vehicle, the processor 500 may provide warning to a user through the interface 100. That is, when a surrounding object is present on the turn-in-place trajectories of the vehicle (e.g., when another vehicle that has parked on the side of the vehicle is present), such a case corresponds to a case in which a sufficient space for a turn-in-place operation of the vehicle has not been secured. In this case, the processor 500 may notify the user that the turn-in-place operation of the vehicle cannot be now performed by outputting warning to the user through the interface 100. The warning may be output through the interface 100 by using various methods, such as a visual method and an auditory method.

### 3. Turn-In-Place Mode

When a manipulation of a user for an around view image that is displayed in the interface 100 corresponds to the third manipulation that has been predefined, the processor 500 determines a motion mode of a vehicle as the parallel mode or the diagonal mode. The parallel mode corresponds to a mode in which a vehicle moves in a transverse direction that is perpendicular to the longitudinal direction of the vehicle. The diagonal mode corresponds to a mode in which a vehicle moves in a diagonal direction.

The third manipulation of a user for determining the parallel mode or the diagonal mode may include the straight drag of a user for the interface 100. That is, the user may determine a motion mode of a vehicle as the parallel mode or the diagonal mode in a way to drag the interface 100 in a straight line form after touching the interface 100. In this case, as illustrated in FIG. 12, when the drag direction of a user is a transverse direction that is perpendicular to the longitudinal direction of the vehicle, the processor 500 may determine a motion mode of the vehicle as the parallel mode. As illustrated in FIG. 14, when the drag direction of a user is a direction that forms an “acute angle” to the transverse direction of a vehicle, the processor 500 may determine a motion mode of the vehicle as the diagonal mode. Furthermore, for distinguishment from the common turn mode, a meaningful time difference may not be present (i.e., the third manipulation does not include “hold”) between touch timing and straight drag timing of a user for the interface 100 in the third manipulation.

In the parallel mode, a target angle of each wheel is determined 90° according to Equation 4. In the diagonal mode, a target angle of each wheel is determined as an “acute angle” (θ_{acute}) that is obtained in response to the third manipulation of a user according to Equation 5.

$${δ}_{fl} = {δ}_{fr} = {δ}_{rl} = {δ}_{rr} = 90 ° \qquad ( 4 )$$

$${δ}_{fl} = {δ}_{fr} = {δ}_{rl} = {δ}_{rr} = {θ}_{acute} \qquad ( 5 )$$

When a target angle of each wheel is determined according to Equations 4 and 5, the processor 500 determines parallel movement trajectories or diagonal movement trajectories of a vehicle, which are formed based on the determined target angles, and provides the parallel movement trajectories or the diagonal movement trajectories (e.g., M1, M2, and M3 in FIGS. 13 and 15) to a user through the interface 100. The parallel movement trajectories and the diagonal movement trajectories may also be displayed through the interface 100 in the form of an around view image. Accordingly, a driver can intuitively check parallel movement trajectories and diagonal movement trajectories of a vehicle to which a four-wheel independent steering system has been applied.

The processor 500 may display, on a road surface, light corresponding to parallel movement trajectories or diagonal movement trajectories of a vehicle through the light radiation module 300, and may output an operation sound to the outside of the vehicle through the sound output module 400 in a process of the vehicle moving along the parallel movement trajectories or the diagonal movement trajectories. Accordingly, a surrounding pedestrian can intuitively check the parallel movement trajectories or diagonal movement trajectories of the vehicle, can walk by avoiding the parallel movement trajectories or diagonal movement trajectories, and can have awareness of the vehicle through the operation sound.

Furthermore, when an object detected by the sensor 200 is present on a parallel movement trajectory or diagonal movement trajectory of a vehicle, the processor 500 may provide warning to a user through the interface 100. That is, when a surrounding object is present on the parallel movement trajectory or diagonal movement trajectory of the vehicle, such a case corresponds to a case in which a sufficient space for the parallel movement trajectory or diagonal movement trajectory of the vehicle has not been secured. In this case, the processor 500 may notify the user that a current parallel movement trajectory or diagonal movement trajectory cannot be executed by outputting warning through the interface 100. The warning may be output through the interface 100 by various methods, such as a visual method and an auditory method.

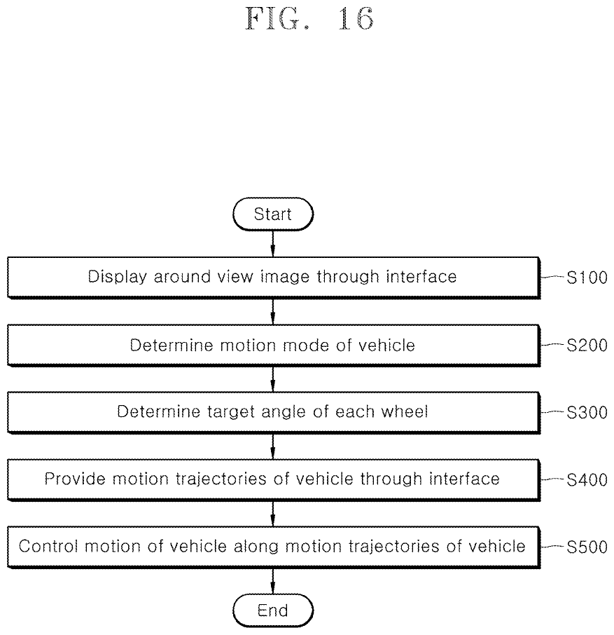

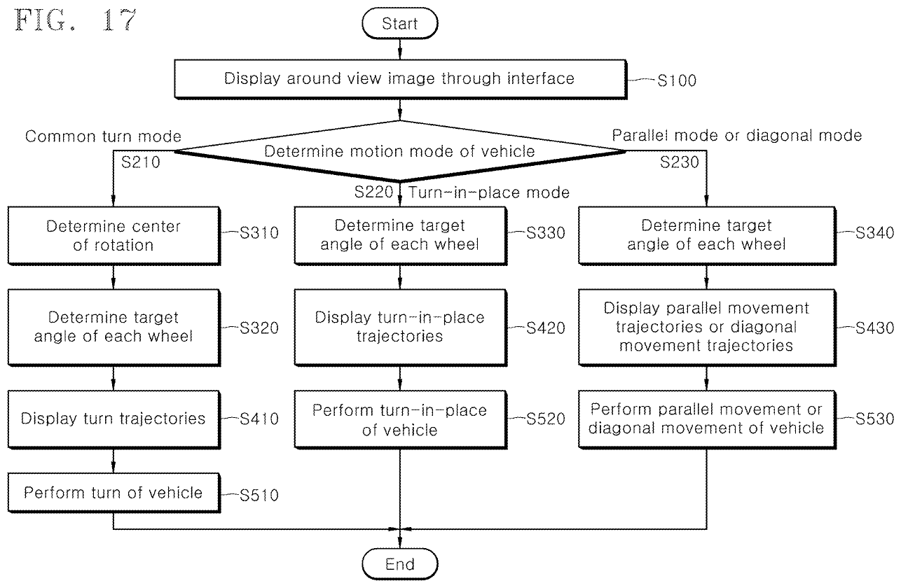

FIGS. 16 and 17 are flowcharts illustrating an operating method of the steering apparatus for a vehicle according to the present embodiment. As illustrated in FIG. 16, the operating method of the steering apparatus for a vehicle according to the present embodiment may include step S100 of displaying an around view image received from the AVM system through the interface 100, step S200 of determining a motion mode of the vehicle based on a manipulation of a user for the interface 100, step S300 of determining target angles of the plurality of wheels corresponding to the determined motion mode, step S400 of providing the user with motion trajectories of the vehicle according to the determined target angles through the interface 100, and step S500 of controlling a motion of the vehicle along the motion trajectories of the vehicle. Hereinafter, the steps are described in detail with reference to FIG. 17.

First, the processor 500 displays the around view image received from the AVM system through the interface 100 (S100).

Next, the processor 500 determines the motion mode of the vehicle in response to the manipulation of the user for the interface 100 (S200). In step S200, the processor 500 determines the motion mode as the common turn mode when the manipulation of the user for the interface 100 corresponds to the first manipulation that has been predefined (S210), determines the motion mode as the turn-in-place mode when the manipulation of the user for the interface 100 corresponds to the second manipulation that has been predefined (S220), and determines the motion mode as the parallel mode or the diagonal mode when the manipulation of the user for the interface 100 corresponds to the third manipulation that has been predefined (S230).

Subsequently to step S210 (i.e., when the motion mode is determined as the common turn mode), the processor 500 determines the center of rotation of the vehicle in response to the first manipulation (or touch) (S310), determines a target angle of each wheel at which the vehicle is turned on the basis of the center of rotation, based on the determined center of rotation and a steering condition that has been predefined for the plurality of wheels (S320), and provides the user with the turn trajectories of the vehicle according to the determined target angles through the interface 100 (S410).

As described above, as the first manipulation further includes a drag subsequent to the touch of the user, the center of rotation in step S310 and the target angle of each wheel in step S320 may be variably determined in response to the drag of the user. Accordingly, in step S410, the processor 500 may provide the user with a process of turn trajectories of the vehicle, which are variably determined as the center of rotation is changed in response to the drag of the user, being changed through the interface 100. Moreover, in step S410, when providing the turn trajectories of the vehicle through the interface 100 in response to the drag of the user by changing the turn trajectories of the vehicle, the processor 500 may provide the turn trajectories of the vehicle to the user through the interface 100 by applying different output methods to a first turn trajectory that overlaps an object detected by the sensor 200 and a second turn trajectory that does not overlap the object detected by the sensor 200.

Thereafter, the processor 500 performs the turn of the vehicle along the final turn trajectory (e.g., the second turn trajectory) that is selected by the user (S510). In step S510, the processor 500 may display, on a road surface, light corresponding to the turn trajectory of the vehicle through the light radiation module 300, and may output an operation sound to the outside of the vehicle through the sound output module 400 in the turn process of the vehicle according to the turn trajectory.

Next, subsequently to step S220 (i.e., when the motion mode is determined as the turn-in-place mode), the processor 500 determines a target angle of each wheel corresponding to the turn-in-place mode (S330), and provides the user with turn-in-place trajectories of the vehicle according to the determined target angles through the interface 100 (S420). Thereafter, the processor 500 performs the turn-in-place of the vehicle along the turn-in-place trajectories (S520). At this time, the processor 500 may display, on a road surface, light corresponding to the turn-in-place trajectories of the vehicle through the light radiation module 300, and may output an operation sound to the outside of the vehicle through the sound output module 400 in the turn-in-place process of the vehicle according to the turn-in-place trajectories.

Next, subsequently to step S230 (i.e., when the motion mode is determined as the parallel mode or the diagonal mode), the processor 500 determines a target angle of each wheel in response to the third manipulation (S340), and provides the user with parallel movement trajectories or diagonal movement trajectories of the vehicle according to the determined target angles through the interface 100 (S430). Thereafter, the processor 500 performs a parallel movement or diagonal movement of the vehicle along the parallel movement trajectories or the diagonal movement trajectories (S530). At this time, the processor 500 may display, on a road surface, light corresponding to the parallel movement trajectories or diagonal movement trajectories of the vehicle through the light radiation module 300, and may output an operation sound to the outside of the vehicle through the sound output module 400 in the movement process of the vehicle according to the parallel movement trajectories or the diagonal movement trajectories.

As described above, according to the present embodiment, a motion trajectory of a vehicle to which a four-wheel independent steering system has been applied and warning according to a surrounding object having a danger of collision when a motion of the vehicle is performed are provided to a user through the interface, so that a driver can intuitively check the motion trajectory of the vehicle to which the four-wheel independent steering system has been applied and a surrounding free space in which the motion of the vehicle is possible has been secured. Accordingly, a sense of driving incompatibility, which occurs in the driver when the motion of the vehicle is performed, can be removed, and a collision against the surrounding object can be effectively prevented.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A steering apparatus for a vehicle, the vehicle including a plurality of independently steered wheels, the apparatus comprising:
one or more processors configured to execute instructions; and
a memory storing the instructions, wherein execution of the instructions configures the one or more processors to:
provide an interface;
assign a motion mode of the vehicle based on a manipulation received by the interface;
determine target angles of the plurality of independently steered wheels corresponding to the assigned motion mode; and
output motion trajectories of the vehicle according to the determined target angles through the interface.

2. The steering apparatus of claim 1, wherein when the manipulation corresponds to a first manipulation that has been predefined, the one or more processors are further configured to:
assign the motion mode to be a common turn mode;
determine a center of rotation of the vehicle in response to the first manipulation;
calculate a target angle of each wheel at which the vehicle is turned on a basis of the center of rotation, based on the determined center of rotation and a predefined steering condition for the plurality of independently steered wheels; and
provide turn trajectories of the vehicle according to the calculated target angles through the interface.

3. The steering apparatus of claim 2, wherein the predefined steering condition includes a condition in which a straight line connecting the center of rotation and each wheel and each wheel are perpendicular to each other, and
wherein the one or more processors are further configured to calculate the target angle of each wheel by using a coordinate of each wheel and a coordinate of the center of rotation as factors, based on a rectangular coordinate system in which a coordinate of any one wheel of the plurality of independently steered wheels is an original point.

4. The steering apparatus of claim 2, wherein the first manipulation is a touch received through the interface,
wherein the center of rotation of the vehicle is determined in response to the received touch, and
wherein the one or more processors are further configured to provide the turn trajectories of the vehicle through the interface in a state in which the touch on the interface has been maintained.

5. The steering apparatus of claim 4, wherein the first manipulation includes a drag across the interface, the drag being received subsequent to the touch,
wherein the center of rotation of the vehicle is variably determined responsive to an input of the drag through the interface, and
wherein the one or more processors are further configured to provide a process of the turn trajectories of the vehicle, the turn trajectories being variably determined as the center of rotation is changed in response to the input of the drag being changed through the interface.

6. The steering apparatus of claim 5, further comprising a sensor configured to detect an object around the vehicle,
wherein when providing the turn trajectories of the vehicle through the interface by changing the turn trajectories of the vehicle in response to the input of the drag, the one or more processors are further configured to provide the turn trajectories of the vehicle through the interface by applying different output methods to a first turn trajectory that overlaps the object detected by the sensor and a second turn trajectory that does not overlap the object detected by the sensor.

7. The steering apparatus of claim 1, wherein when the interface is configured to receive a second manipulation that has been predefined,
wherein the one or more processors are further configured to: assign the motion mode to be a turn-in-place mode;
calculate a target angle of each wheel corresponding to the turn-in-place mode; and
provide turn-in-place trajectories of the vehicle according to the calculated target angles through the interface.

8. The steering apparatus of claim 1, wherein when the interface is configured to receive a third manipulation that has been predefined, and
wherein the one or more processors are further configured to:
assign the motion mode to be one of a parallel mode or a diagonal mode;
calculate a target angle of each wheel in response to the third manipulation; and
provide one of parallel movement trajectories or diagonal movement trajectories of the vehicle according to the calculated target angles through the interface.

9. The steering apparatus of claim 1, further comprising:
a light radiation module configured to radiate light to an outside of the vehicle; and
a sound output module configured to output a sound to the outside of the vehicle,
wherein the one or more processors are further configured to:
instruct the light radiation module to display, on a road surface, light corresponding to the motion trajectory of the vehicle; and
instruct the sound output module to output an operation sound in a motion process of the vehicle.

10. A steering apparatus for a vehicle, comprising:
one or more processors configured to execute instructions; and
a memory storing the instructions, wherein execution of the instructions configures the one or more processors to:
provide an interface; and
calculate a target angle of each wheel of the vehicle at which the vehicle is turned on a basis of a center of rotation, based on the center of rotation of the vehicle that is determined in response to a manipulation received by the interface and a steering condition that has been predefined for wheels of the vehicle,
wherein the wheels of the vehicle are configured to be independently steered; and
provide turn trajectories of the vehicle based on the calculated target angles through the interface.

11. A processor-implemented method for controlling steering apparatus for a vehicle, the vehicle comprising independently steered wheels, the method comprising:
assigning a motion mode of the vehicle based on a manipulation received by an interface;
determine target angles of the independently steered wheels corresponding to the assigned motion mode; and
output motion trajectories of the vehicle according to the determined target angles through the interface.

12. The method of claim 11, further comprising:
determining a center of rotation of the vehicle responsive to a first manipulation received through the interface;
calculating a target angle of each wheel at which the vehicle is turned on a basis of the center of rotation, based on the determined center of rotation and a predefined steering condition for the independently steered wheels; and
providing turn trajectories of the vehicle according to the calculated target angles through the interface.

13. The method of claim 11, further comprising:
assigning the motion mode to be a common turn mode responsive to a first manipulation.

14. The method of claim 11, further comprising, responsive to receiving a second predefined manipulation:
assigning the motion mode to be a turn-in-place mode;
calculating a target angle of each wheel corresponding to the assigned turn-in-place mode; and
displaying turn-in-place trajectories of the vehicle according to the calculated target angles through the interface.

15. The method of claim 11, further comprising, responsive to receiving a third predefined manipulation:
assigning the motion mode to be one of a parallel mode or a diagonal mode;
calculating a target angle of each wheel; and
displaying one of parallel movement trajectories or diagonal movement trajectories of the vehicle according to the calculated target angles through the interface.
